(19) United States
(12) Patent Application Publication
(10) Pub. No.: US 2004/0109091 A1
(43) Pub. Date: Jun. 10, 2004

(54) Apparatus and method for adaptive brightness control

(75) Inventors: Yung-Jun Park, Yongin City (KR); Seung-Joon Yang, Suwon City (KR); Jae-Hwan Oh, Suwon City (KR); Hyun Kang, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/725,448

(22) Filed: Dec. 3, 2003

Related U.S. Application Data
(60) Provisional application No. 60/430,333, filed on Dec. 3, 2002.

(30) Foreign Application Priority Data
Mar. 11, 2003 (KR) 2003-15015

(51) Int. Cl. H04N 5/14

(52) U.S. Cl. 348/673; 382/255

(57) ABSTRACT

Disclosed is a brightness control apparatus and method capable of adaptively compensating brightness values based on an average brightness of an image signal. The adaptive brightness control apparatus comprises a probability density function (PDF) calculation unit calculating a PDF based on a distribution of pixel values of pixels of an input image signal, a compensation value calculation unit for calculating an average value of the pixel values of the respective pixels, and calculating a function having a predetermined slope according to a range of the average brightness value, and a pixel value compensation unit for re-establishing the distribution of the pixel values based on the calculated function. The brightness control apparatus adaptively corresponds to the brightness of an input image signal preventing flickering, and does not require an additional hardware structure, when additionally requiring a function for compensating brightness values, by implementing the required function through conversion of embedded function values.

### CROSS-REFERENCE TO RELATED APPLICATIONS

This application claims the benefit of U.S. Provisional Patent Application No. 60/430,333 filed Dec. 3, 2002 in the U.S. Patent and Trademark Office, and Korean Patent Application No. 2003-15015 filed Mar. 11, 2003, the disclosures of which are incorporated herein by reference.

### BACKGROUND OF THE INVENTION

1. Field of the Invention

The present invention relates to a brightness control apparatus and method, and more particularly, to a brightness control apparatus and method capable of adaptively controlling brightness according to an average brightness of an image signal with little or no hardware added.

2. Description of the Related Art

Generally, upon processing a video image signal, an unbalance or distortion of brightness in the image signals, frequently occurs due mainly to varying factors such as lightings, photographing conditions, and features of a video display device. It is true that, in many occasions, the brightness of even the same image signal varies according to the type of video display device which reproduces the image signal. For example, when the same image signal is input and reproduced through different video display devices, the image signal has different brightness in low and high brightness regions according to characteristics of a video display device displaying the image signal. In order to control such difference in brightness, a video display device generally has an Automatic Gain Control (AGC) unit therein. The AGC unit operates automatically, or may be manually controlled by a user, to increase or decrease image brightness.

FIG. 1 is a block diagram showing a conventional brightness control apparatus having an AGC unit.

A brightness control apparatus shown in FIG. 1 has a brightness level detection unit 10, an AGC unit 20, and a mapping unit 30.

The average value calculation unit 10 calculates an average value of the brightness of an input image signal. The brightness control unit 20 increases or decreases an output gain of the brightness of an input image signal if an average brightness value calculated in the average value calculation unit 10 is higher or lower than a pre-set brightness value. That is, the brightness control unit 20 outputs a gain function to increase or decrease a brightness value of an input image signal.

The mapping unit 30 carries out mapping with respect to an input image signal for an output according to the gain function outputted from the brightness control unit 20.

FIG. 2A and FIG. 2B are graphs showing gain functions outputted from the brightness control unit 20.

A gain function shown in FIG. 2A is output to the mapping unit 30 if the brightness of an input image signal applied to the brightness control unit 20 is lower than a brightness value stored in advance in the brightness control unit 20. On the contrary, a gain function shown in FIG. 2B is output to the mapping unit 30 if the brightness of an input image signal applied to the brightness control unit 20 is higher than a brightness value stored in advance in the brightness control unit 20. Accordingly, in case that an input image signal has little or no changes overall but an image has a bright or dark portion thereon, a phenomenon occurs that the image becomes abruptly bright or dark beyond necessity when the input image signal is controlled by the brightness control unit 20 and displayed on a screen.

### SUMMARY OF THE INVENTION

The present invention has been devised to solve the above and/or other problems, so it is an aspect of the present invention to provide a brightness control apparatus and method implemented in a simple hardware structure and adaptively matching brightness with that of an input image signal.

In an effort to achieve the above and/or other aspects and features of the present invention, there is provided an apparatus for adaptive brightness control, including a probability density function (PDF) calculation unit for calculating a PDF based on a distribution of pixel values of pixels of an input image signal, a compensation value calculation unit for calculating an average value of the pixel values of the respective pixels, and calculating a function having a predetermined slope according to a range of the average brightness value, and a pixel value compensation unit for re-establishing the distribution of the pixel values based on the calculated function.

The pixel value compensation unit includes a PDF compensation unit for comparing values of the calculated function with PDF values obtained by the PDF calculation unit, a cumulative distribution function (CDF) generation unit for calculating a cumulative distribution function for the PDF re-established by the pixel value compensation unit, and a mapping unit for re-establishing pixel values of the input image signal based on the cumulative distribution function.

The CDF generation unit calculates a CDF for the PDF based on the following formula:

$$CDF ( K ) = {\sum }_{t = 0}^{t} PDF ( t )$$

wherein CDF(K) denotes a cumulative distribution function, PDF(t) is a probability density function, and t is a maximum pixel value displayable when the image signal is displayed on a screen.

Further provided is a cumulative distribution function (CDF) compensation unit which is provided between the CDF generation unit and the mapping unit, to calculate a compensated CDF from outputs of the CDF generation unit based on the following formula:

$${CDF}^{′} ( K ) = CDF ( K ) - \frac{CDF ( N - 1 )}{N - 1} K + F ( K )$$

wherein CDF′(K) denotes a compensated cumulative distribution function, CDF(K) is a cumulative distribution function before compensation, F(K)=(the total number of pixels of an image signal/(N−1))K, N−1 is a maximum pixel value, and CDF(N−1) is a value of the cumulative distribution function at the maximum pixel value.

The compensation value calculation unit includes an average value calculation unit for calculating an average pixel value, an average value range calculation unit for setting a range of the calculated average pixel value, and a function value output unit for outputting to the pixel value compensation unit a function corresponding to the range of the calculated average value.

The function is one among a monotonic increasing function, a monotonic decreasing function, and a constant function.

The pixel value is one among the brightness value, a grayscale value of three primary colors R, G, B and a grayscale value of color difference signals Y, Cb, Cr.

According to an aspect of the present invention, an adaptive brightness control method includes the operations of calculating a probability density function (PDF) based on a distribution of pixel values of respective pixels of an input image signal, calculating an average pixel value of the detected pixel values, and calculating a function having a predetermined slope according to a range of the average pixel value, and re-establishing the distribution of the pixel values based on the calculated function.

The operation for re-establishing the brightness value distribution includes the operations of comparing values of the calculated function with values of the calculated PDF, and increasing and decreasing a part of the PDF values, calculating a cumulative distribution function for the PDF which has the increased and decreased PDF values, and re-establishing pixel values of the input image signal based on the cumulative distribution function.

The operation of calculating the cumulative distribution function further comprises the operation of re-establishing the cumulative distribution function based on the following formula:

$${CDF}^{′} ( K ) = CDF ( K ) - \frac{CDF ( N - 1 )}{N - 1} K + F ( K )$$

wherein CDF′(K) denotes a compensated cumulative distribution function, CDF(K) is a cumulative distribution function before compensation, F(K)=(the total number of pixels of an image signal/(N−1))K, N−1 is a maximum pixel value, and CDF(N−1) is a value of the cumulative distribution function at the maximum pixel value.

The operation of calculating the function having the predetermined slope comprises the operation of calculating an average value of the pixel values, setting a range of the calculated average pixel value, and calculating a function corresponding to the range of the calculated average pixel value.

The function is one of a monotonic increasing function, a monotonic decreasing function, and a constant function.

The pixel value is one among the brightness value, a grayscale value of three primary colors R, G, B and a grayscale value of color difference signals Y, Cb, Cr.

Additional aspects and/or advantages of the invention will be set forth in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects of the present invention, taken in conjunction with the accompanying drawings of which:

FIG. 1 is a block diagram of a conventional brightness control apparatus;

FIG. 2A and FIG. 2B are graphs showing cumulative distribution functions output from a brightness control unit of FIG. 1;

FIG. 3 is a block diagram of a brightness control apparatus according to an aspect of the present invention;

FIG. 4 is a block diagram of a compensation value calculation unit of FIG. 3;

FIG. 5A to FIG. 6C are views for illustrating the operation of a brightness compensation unit of FIG. 3; and

FIG. 7 is a flow chart illustrating an adaptive brightness control method according to an aspect of the present invention.

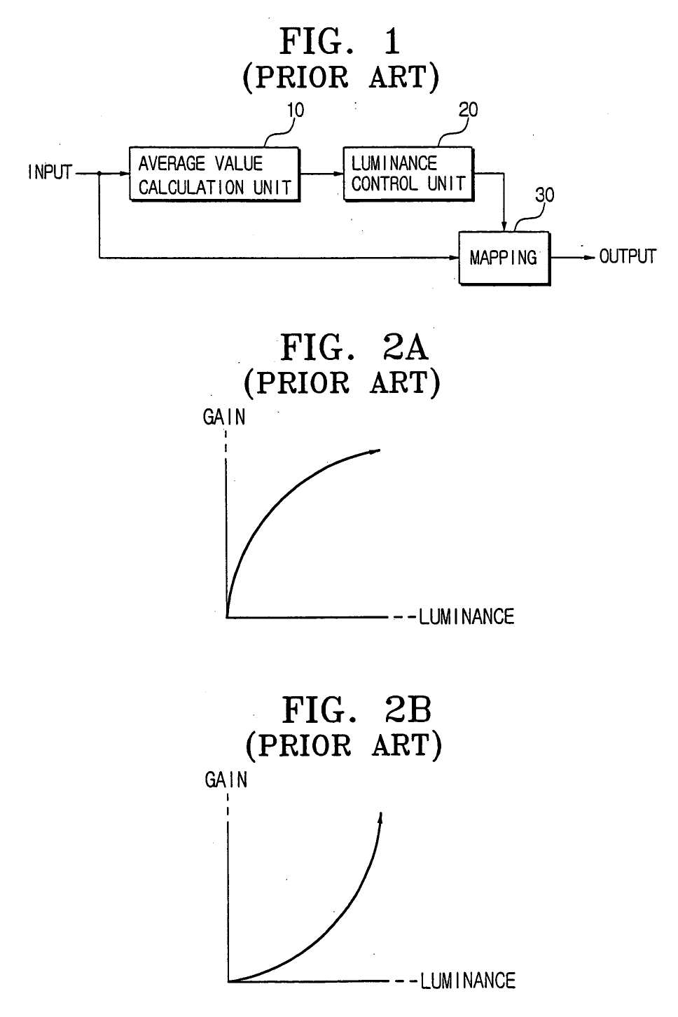

### DETAILED DESCRIPTION OF THE PREFERRED EMBODIMENTS

Reference will now be made in detail to the aspects of the present invention, examples of which are illustrated in the accompanying drawings, wherein like reference numerals refer to like elements throughout. The aspects are described below in order to explain the present invention by referring to the figures.

FIG. 3 is a block diagram showing a brightness control apparatus according to an aspect of the present invention.

The brightness control apparatus shown in FIG. 3 has a probability density function (PDF) calculation unit 100, a compensation value calculation unit 200, a brightness control (or Bit Under threshold Bit Over threshold (BUBO) unit 300, a cumulative distribution function (CDF) generation unit 400, a CDF compensation unit 410, and a mapping unit 500.

The PDF calculation unit 100 detects pixel values of each pixel forming an input image signal and calculates a probability density function (PDF) based on the detected result. The pixel value can be the brightness value, a grayscale value of three primary colors R, G, B, or a grayscale value of color difference signals Y, Cb, Cr. Also, the grayscale value can be based on the hue, the saturation or the brightness. Representing the grayscale value by 8-bits will render the primary colors R, G, B and the saturation in 256 levels (i.e., 28 levels). The brightness value can also be expressed by 256 levels, and the color difference signals Y, Cb, and Cr can be expressed by 8 bits, respectively. Accordingly, the brightness value, grayscale value of the primary color signals and grayscale value of the color difference signal vary in accordance with the variation of the brightness value of the input image signal, and the PDF corresponding to the variation of brightness of input image signal can be calculated. The brightness control apparatus according to the present invention will be described mainly with reference to the brightness value of the input image signal. However, it should be noted that the present invention is equally applicable to the grayscale values of the three primary colors R, G, B and the color difference signals.

The compensation value calculation unit 200 calculates an average value of a brightness value based on the PDF, and compares the calculated average value with a predetermined range. Further, the compensation value calculation unit 200 has therein functions corresponding to pre-set ranges, and outputs a different function to the BUBO unit 300 according to a result of the comparison.

The BUBO unit 300 converts the PDF output from the PDF calculation unit 100 according to a function output from the compensation value calculation unit 200. The converted PDF is compared with a function output to the BUBO unit 300, and values which are smaller than the values of the function are mapped into the function values.

The CDF generation unit 400 sequentially accumulates and calculates PDFs output from the BUBO unit 300. The cumulative distribution function is defined in Formula 1 as follows:

$$CDF = {\sum }_{i = 0}^{n} PDF , wherein i = 0 , 1 , 2 , 3 , \qquad [ Formula 1 ]$$

The CDF compensation unit 410 compensates a maximum value of a cumulative distribution function (CDF) calculated in the CDF generation unit 400 to be equal to the total number of pixels of the input image signal, and, after the compensation of the cumulative distribution function, the compensated cumulative distribution function is normalized. The normalization converts a cumulative distribution function of brightness versus the number of pixels into a function of brightness levels of an input image signal versus output brightness levels corresponding thereto. The compensation and normalization of a cumulative distribution function are based on Formula 2 and Formula 3 as follows:

$${CDF}^{′} ( K ) = CDF ( K ) - \frac{CDF ( N - 1 )}{N - 1} K + F ( K ) , \qquad [ Formula 2 ]$$

wherein CDF′(K) denotes a compensated cumulative distribution function, CDF(K) is a cumulative distribution function before compensation, F(K)=(the total number of pixels of an image signal/(N−1))K, N−1 is a maximum brightness value, and CDF(N−1) is a value of the cumulative distribution function at the maximum brightness value.

$$F ( K ) = {CDF}^{′} ( K ) \times \frac{maximum luminance}{total number of pixels of an image signal} \qquad [ Formula 3 ]$$

wherein F(K) denotes a normalized cumulative distribution function, that is, a mapping function, and CDF′(K) a compensated cumulative distribution function.

The mapping unit 500 maps brightness of each pixel forming an input image signal according to a result of the normalization.

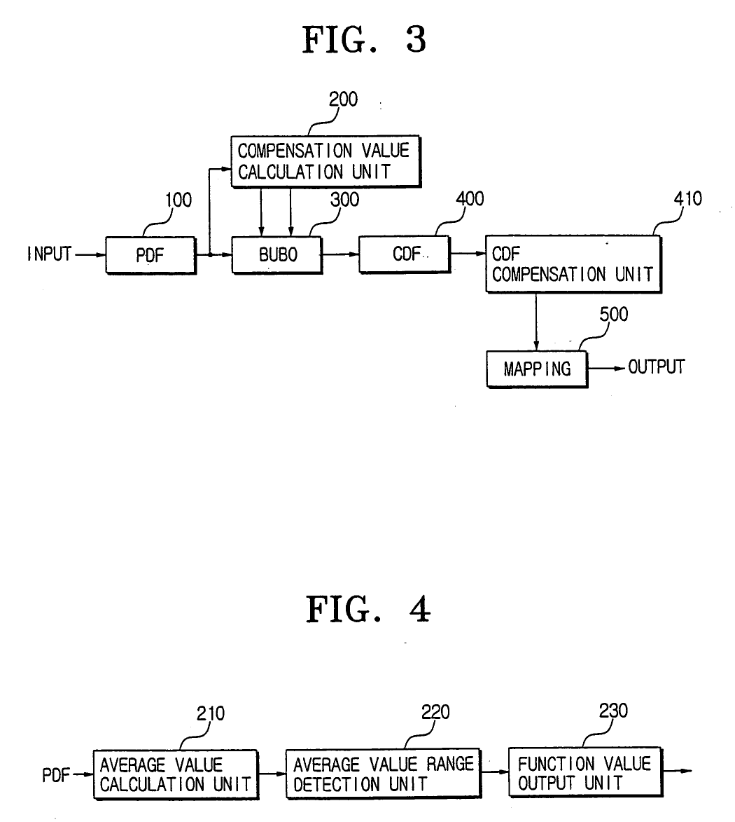

FIG. 4 is a detailed block diagram of the compensation value calculation unit 200 of FIG. 3. The compensation value calculation unit 200 shown in FIG. 4 has an average value calculation unit 210, an average value range detection unit 220, and a function value output unit 230.

The average value calculation unit 210 calculates an average brightness value of an input image signal based on the PDF applied from the PDF unit 100. The average value range detection unit 220 detects in which range the average brightness value calculated in the average value calculation unit 210 is placed. Table 1 explains the operation of the average value calculation unit 210, in which brightness values in a range of 0˜255 are classified into 4 levels and functions corresponding to the levels are shown.

TABLE 1

| | | | | |
|---|---|---|---|---|
| Average | 0˜30 | 31˜100 | 101˜159 | 159˜255 |
| Brightness | | | | |
| Values | | | | |
| Corresponding | y = −ax + b | y = −cx + d | Y = e | y = fx + g |
| Functions | | | | |

As shown in Table 1, the average values have corresponding functions depending upon levels of 0˜30, 31˜100, 101˜159, and 159˜255. If an average value output from the average value calculation unit 210 is 20, a corresponding function is expressed by y=−ax+b, and, if in a range of 160˜255, a corresponding function becomes y=fx+g. Table 1 shows the four-level average brightness values in order to explain the operation of the average value range calculation unit 220, but the present invention is not defined thereby. The function value output unit 230 has therein functions corresponding to a range of an average brightness value, and outputs a corresponding function to the BUBO unit 300.

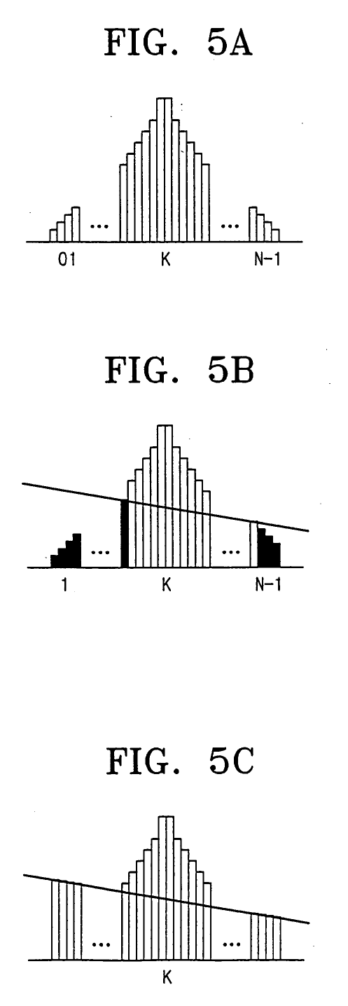

FIG. 5A to FIG. 5C illustrate the operation of the BUBO unit 300.

First, FIG. 5A is a view showing a PDF of an image signal output from the PDF calculation unit 100. An average value of the PDF shown is assumed to have a brightness value of 80 in the average value calculation unit 210.

FIG. 5B shows a PDF and a function that corresponds when an average brightness value calculated in the average value calculation unit 210 is 80. At this time, the BUBO unit 300 compares function values applied from the compensation value calculation unit 200 with a PDF, and increases PDF values that are less than the function value. FIG. 5C shows a result when the PDF values smaller than the function value have been increased. As shown in FIG. 5C, as PDF values in a region having low brightness values in the PDF increase, the entire brightness of an input image signal increases according to the increased PDF values. At this time, since the function, for example, y=−ax+b, monotonically decreases, brightness values are simultaneously compensated in high and low regions as PDF values increase. When such a compensated image signal is displayed on a display device such as a screen, an image is brightness-compensated, avoiding abrupt changes in brightness.

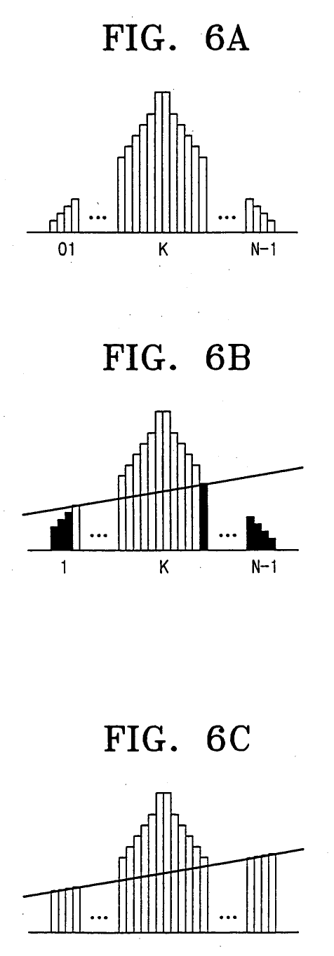

FIG. 6A to FIG. 6C are views illustrating functions and PDFs corresponding when an average brightness value calculated in the average value calculation unit 210 is 170. A function corresponding to the average brightness value is expressed by y=fx+g as shown in Table 1, and the BUBO unit 300 compares the PDF and function values and increases PDF values smaller than the function values. The PDF values are increased in a low brightness level region, that is, in a dark region of the PDF, and the increased brightness values of this region decreases the entire brightness of an input image signal. The low and high brightness regions are simultaneously compensated based on a function such as y=fx+g, so that an image is brightness-compensated without becoming abruptly dark when the compensated image signal is displayed on a display device such as a screen. That is, an image signal compensated through the brightness control apparatus according to the present invention does not become abruptly bright or dark when displayed on the screen. Further, since brightness values can be compensated with a function applied depending upon each region, there is no need to have additional hardware for brightness value compensation even when it is necessary to additionally compensate brightness values.

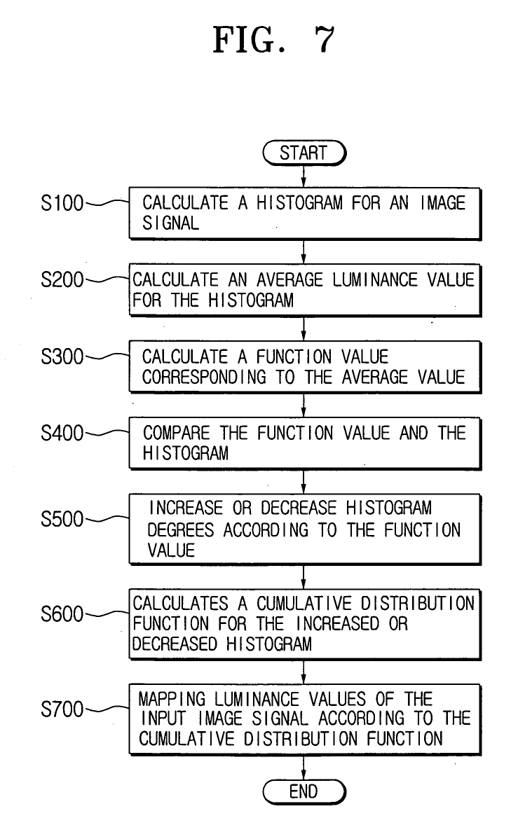

FIG. 7 is a flow chart for showing an adaptive brightness control method according to an aspect of the present invention.

First, the PDF calculation unit 100 detects the pixel values of the respective pixels forming an input image signal and calculates a PDF based on the detected result (S100). The pixel value can be the brightness value, a grayscale value of three primary colors R, G, B, or a grayscale value of color difference signals Y, Cb, Cr. Also, the grayscale value can be based on the hue, the saturation or the brightness. Representing the grayscale value by 8-bits will render the primary colors R, G, B and the saturation in 256 levels (i.e., 28 levels). The brightness value can also be expressed by 256 levels, and the color difference signals Y, Cb, Cr can be expressed by 8 bits, respectively. Accordingly, the brightness value, grayscale value of the primary color signals and grayscale value of the color difference signal vary in accordance with the variation of the brightness value by the input image signal, and the PDF corresponding to the variation of brightness of the input image signal can be calculated. In the following description, the brightness control apparatus according to the present invention will be described mainly with reference to the brightness value of the input image signal. However, it should be noted that the present invention is equally applicable to the grayscale values of the three primary colors R, G, B and the color difference signals.

Next, the average value calculation unit 210 calculates an average brightness value from the calculated PDF (S200). The average brightness value at this time is a value obtained from adding and dividing all the brightness values distributed in the PDF by the total number of pixels. Next, the average value range detection unit 220 detects in which range the average brightness value, among the brightness values of 0˜255 levels, is located. At this time, the average value range detection unit 220 classifies the brightness levels of 0˜255 into four to ten ranges, for example, 0˜30, 31˜100, 101˜159, and 159˜255, and so on, and detects in which range the average brightness value belongs. Next, the function value output unit 230 outputs to the BUBO unit 300 function values based on a function corresponding to the range detected in the average value range detection unit 220 (S300). In here, the function is a monotonic increasing function or a monotonic decreasing function. The BUBO unit 300 compares a function value output from the function value output unit 230 with the PDF output from the PDF calculation unit 100 (S400), maps PDF values into the function value by increasing or decreasing the PDF values in case that the PDF values are smaller than the function value as a result of the comparison, and outputs the mapped PDF to the CDF compensation unit 410 (S500). The CDF calculation unit 410 accumulates the PDFs compensated by the BUBO unit 300 and calculates a cumulative distribution function (S600). At this time, when the BUBO unit 300 compensates the PDF, some particular brightness degrees are increased or decreased so that, when a cumulative distribution function is calculated based on the increase or decrease, a final cumulative value of the cumulative distribution function exceeds or becomes smaller than a pixel value the input image signal has. Accordingly, the CDF compensation unit 410 compensates a maximum value of a cumulative distribution function (CDF) calculated in the CDF generation unit 400 to the total number of pixels the input image signal, and converts the compensated cumulative distribution function to a relations of input brightness values versus output brightness values. Normalization is implemented based on Formula 3 as above.

Lastly, the mapping unit 500 maps the input image signal into a normalized cumulative distribution function (S700). Accordingly, the present invention controls the BUBO unit 300 according to a function output from the compensation value calculation unit 200 when compensating brightness values, to thereby avoid additional hardware when adding a function for compensating brightness values. The brightness control apparatus and method according to the present invention can solve a problem of additional hardware by changing or converting functions embedded in the compensation value calculation unit 200.

As stated above, the present invention does not require an additional hardware structure by changing embedded function values when requiring a function for compensating additional brightness values. Further, the present invention applies at least one or more embedded functions by brightness region to avoid abrupt brightness changes when compensating the brightness of an image signal, so that image quality is not deteriorated when the brightness control apparatus is applied to an image display device.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for adaptive brightness control, comprising:
a probability density function (PDF) calculation unit calculating a PDF based on a distribution of pixel values of pixels of an input image signal;
a compensation value calculation unit calculating an average value of the pixel values of the respective pixels, and calculating a function having a predetermined slope according to a range of an average brightness value; and
a pixel value compensation unit re-establishing the distribution of the pixel values based on the calculated function.

2. The apparatus as claimed in claim 1, wherein the pixel value compensation unit includes:
a PDF compensation unit comparing values of the calculated function with PDF values obtained by the PDF calculation unit;
a cumulative distribution function (CDF) generation unit calculating a cumulative distribution function for the PDF re-established by the pixel value compensation unit; and
a mapping unit re-establishing pixel values of the input image signal based on the cumulative distribution function.

3. The apparatus as claimed in claim 2, wherein the CDF generation unit calculates a CDF for the PDF based on the following formula:
$$CDF ( K ) = {\sum }_{t = 0}^{t} PDF ( t )$$
wherein CDF(K) denotes a cumulative distribution function, PDF(t) is a probability density function, and t is a maximum pixel value displayable when the image signal is displayed on a screen.

4. The apparatus as claimed in claim 3, further comprising a cumulative distribution function (CDF) compensation unit provided between the CDF generation unit and the mapping unit, to convert outputs of the CDF generation unit based on the following formula:
$${CDF}^{′} ( K ) = CDF ( K ) - \frac{CDF ( N - 1 )}{N - 1} K + F ( K )$$
wherein CDF′(K) denotes a compensated cumulative distribution function, CDF(K) is a cumulative distribution function before compensation, F(K)=(the total number of pixels of an image signal/(N−1))K, N−1 is a maximum pixel value, and CDF(N−1) is a value of the cumulative distribution function at the maximum pixel value.

5. The apparatus as claimed in claim 1, wherein the compensation value calculation unit includes:
an average value calculation unit calculating an average pixel value;
an average value range calculation unit setting a range of the calculated average pixel value; and
a function value output unit outputting to the pixel value compensation unit a function corresponding to the range of the calculated average value.

6. The apparatus as claimed in claim 1, wherein the function is one among a monotonic increasing function, a monotonic decreasing function, and a constant function.

7. The apparatus as claimed in claim 1, wherein the pixel value is one among the brightness value, a grayscale value of three primary colors R, G, B and a grayscale value of color difference signals Y, Cb, Cr.

8. An adaptive brightness control method, comprising:
calculating a probability density function (PDF) based on a distribution of pixel values of respective pixels of an input image signal;
calculating an average pixel value of the detected pixel values, and calculating a function having a predetermined slope according to a range of the average pixel value, and
re-establishing the distribution of the pixel values based on the calculated function.

9. The adaptive brightness control method as claimed in claim 8, wherein the re-establishing the brightness value distribution includes:
comparing values of the calculated function with values of the calculated PDF, and increasing and decreasing a part of the PDF values;
calculating a cumulative distribution function for the PDF which has the increased and decreased PDF values; and
re-establishing pixel values of the input image signal based on the cumulative distribution function.

10. The adaptive brightness control method as claimed in claim 9, wherein the calculating the cumulative distribution function further comprises re-establishing the cumulative distribution function based on the following formula:
$${CDF}^{′} ( K ) = CDF ( K ) - \frac{CDF ( N - 1 )}{N - 1} K + F ( K )$$
wherein CDF′(K) denotes a compensated cumulative distribution function, CDF(K) is a cumulative distribution function before compensation, F(K)=(the total number of pixels of an image signal/(N−1))K, N−1 is a maximum pixel value, and CDF(N−1) is a value of the cumulative distribution function at the maximum pixel value.

11. The adaptive brightness control method as claimed in claim 8, wherein the calculating the function having the predetermined slope comprises:
calculating an average value of the pixel values;
setting a range of the calculated average pixel value; and
calculating a function corresponding to the range of the calculated average pixel value.

12. The adaptive brightness control method as claimed in claim 8, wherein the function is one of a monotonic increasing function, a monotonic decreasing function, and a constant function.

13. The adaptive brightness control method as claimed in claim 8, wherein the pixel value is one among the brightness value, a grayscale value of three primary colors R, G, B and a grayscale value of color difference signals Y, Cb, Cr.
